(19) United States
(12) Patent Application Publication
(10) Pub. No.: US 2009/0020071 A1
(43) Pub. Date: Jan. 22, 2009

(54) Spray can that sprays chrome-like coating

(76) Inventor: Ike Banoun, Vernon, CA (US)

Correspondence Address: LEON D. ROSEN;FREILICH, HORNBAKER & ROSEN, Suite 1220, 10960 Wllshire Blvd., Los Angeles, CA, 90024, US

(21) Appl. No.: 11/879,068

(22) Filed: Jul. 16, 2007

(51) Int. Cl. B05B 7/24; B05D 1/12

(52) U.S. Cl. 118/308; 239/337; 427/180

(57) ABSTRACT

A spray can (10) that sprays a coating resembling a chrome plating, includes a pressure container (12) containing a paint (14) formed by extremely thin small aluminum particles (20) obtained by scraping off a metalized layer from a substrate, the particles lying in a liquid carrier (22). The can contains a propellant (24) that creates an unusually high pressure to effectively force the paint though a spray nozzle (26). The spay nozzle has a spray aperture (30) whose cross-section is elongated to produce a fan-shaped spray which eliminates splotches.

### BACKGROUND OF THE INVENTION

Spray cans are available that spay a coating that resembles an aluminum plating or sheet, but not one that resembles a chrome plating. A sprayed coating that resembles aluminum has a gloss factor of under 68 (and reflects no more than 90% of incident light), while a sprayed coating that resembles chrome has a gloss factor of well over 68 (and reflects more than 98% of incident light). The difference is readily apparent when viewed outdoors when the sun is shining. The prior art sprayed coating that resembles aluminum is obtained by grinding a bar of aluminum to produce particles having a width, length and thickness that are each about 0.003 inch, mixing the particles in a clear liquid carrier such as a urethane, a laquer, an enamel, etc., to produce a prior art paint, and spraying the prior art paint using a common spray can. The spray can contained a propellant such as propane gas that produced a pressure of about 10 psi, and the paint was sprayed though a nozzle having a circular cross section. This is the same type of common paint can that is used to spray paints of selected colors. A spray can that could spray a coating that resembled a chrome plated surface would be of value.

### SUMMARY OF THE INVENTION

In accordance with one embodiment of the present invention, applicant provides a spray can that can spay a coating that resembles a chrome plating. Applicant uses a spray paint can of the type that includes a pressure container, a quantity of paint, a propellant that pressurizes the paint and a nozzle though which the paint can be sprayed. However, instead of using prior art paint formed by ground aluminum particles in a carrier, applicant uses much thinner particles, obtained by scraping a metalized layer off a substrate. The particles are uniformly very thin and are mixed into a carrier liquid. A propellant used to spray the paint produces a higher pressure than common paint can propellants, as applicant finds this is necessary to obtain a good spraying. Also, the nozzle opening though which the paint is sprayed, has an elongated cross-section instead of the usual circular cross-section. Applicant finds that the resulting fan-shaped spray avoids spotting and paint pooling in the sprayed-on layer, resulting in an even sprayed-on layer having a chrome appearance when the carrier dries.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a sectional view of a spray can of the present invention.

FIG. 2 is an enlarged sectional view of a spayed-on layer of the invention.

FIG. 3 is an enlarged sectional view of a spray nozzle of the spay can of FIG. 1.

### DESCRIPTION OF THE INVENTION

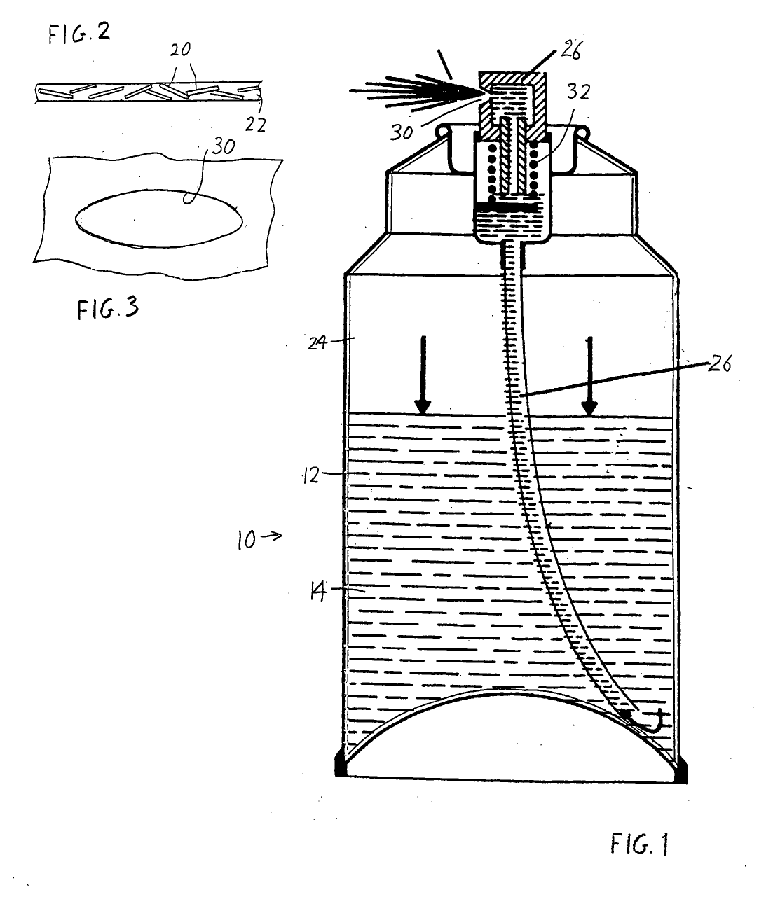

FIG. 1 is a sectional view of a spray can 10 of the present invention, which has an overall appearance similar to that of prior art spray cans. The spay can includes a pressure container 12 with a lower portion containing paint 14 to be sprayed, and with an upper portion containing a propellant 24 that pressurizes the paint. A nozzle 26 at the top of the container has a spray aperture 30 through which paint is sprayed when the nozzle is depressed against the force of a spring 32 to open the pathway for paint to reach the nozzle. A tube 26 extends from near the bottom of the container to the nozzle. This basic construction is known in the prior art.

There have been attempts to spray a coating on a smooth surface so as to create a surface resembling a chrome plating A chrome plating has a gloss factor of at least 68 (it reflects at least 98% of incident light and reflects images). Previous attempts have used aluminum particles obtained by grinding a piece of aluminum. This results in particles each about 0.003 inch in width length and thickness. The particles were placed in a transparent carrier liquid such as a urethane, a laquer, an enamel, etc., and the liquid with particles therein was placed in a spray can containing a propellant such as a propane blend which produces a pressure of about 10 psi. When sprayed onto a smooth surface and dried, the resulting coating had a gloss index of under 68 (a reflectivity of about 90%), and appeared to be the surface of polished aluminum.

Applicant obtains very thin particles of aluminum by metalizing a substrate. This can be done by electroplating a substrate to which aluminum does not adhere well, and scraping off the aluminum to generate particles. This is a known technique. The particles each has a thickness on the order of magnitude of 0.0005 inch and a greater width and length. Applicant mixes the particles obtained by metalizing, with a transparent carrier liquid such as alcohol or a urethane blend and places it in a spray can with a propellant.

Applicant finds that a prior art propellant such as propane which produces a pressure of about 10 psi, does not produce a proper spray coating. Instead, applicant uses a propane blend as a propellant which produces a pressure of more than 15 psi, and preferably 20 psi or greater. This results in a largely even spray. Applicant believes that the present aluminum particles of a very small thickness, shown at 20 in FIG. 2, allow much of the propellant to pass by the particles instead of keeping the propellant behind the particles to push them forcefully against the surface being coated. However, even with the increased pressure, applicant found that the spray creates some splotchiness, that is, areas with excessive paint. Applicant has also found that splotchiness can be avoided by constructing the nozzle with an aperture that is not of round cross section, but that is of an elongated cross section such as shown in FIG. 3, with a length to width ratio of at least 1.5 to 1. This results in a fan-shaped spray pattern, which can be used to apply an even coating to a surface.

In a spray can that applicant has constructed and sucessfully tested, applicant loaded a liquid mixture into the can that included a carrier liquid of an alcohol and urethane blend and aluminum particles each having a thickness on the order of 0.0005 inch and a width and length each on the order of 0.003 inch. A propellant of a propane blend was also loaded into the can. The nozzle had an elliptical aperture of a width to height ratio of 3 to 1. The spray can was used to spray coatings on smooth surfaces, and the dried coatings had the appearance of a chrome plating.

Thus, the invention provides a spray can of moderate cost that can produce a coating of especially high reflectivity to resemble a chrome plating. The can includes a mixture of very thin particles of aluminum in a liquid carrier. The propellant in the can produces an especially high pressure, which applicant found necessary to effectively spray the very thin particles. The spray nozzle opening is elongated instead of being of round cross section, with one cross sectional dimension being at least 1.5 times that of the perpendicular dimension.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A spray can that sprays a chrome-like paint layer onto a surface, which includes a can that holds paint comprising aluminum particles and a liquid carrier and that holds a propellant that lies above the paint, a nozzle that sprays paint, and a tube that carries paint to the nozzle, wherein:
said aluminum particles of said paint comprise metalized particles each having a thickness on the order of magnitude of 0.0005 inch;
said propellant is constructed to apply a pressure above 15 psi to the paint in said spray can.

2. The spray can described in claim 1, wherein:
said nozzle has an elliptical opening with a width-to-height ration of at least 150%, to spray a fan-shaped area of a workpiece, whereby to avoid paint spotting.

3. The spray can described in claim 1 wherein:
said pressure is at least 20 psi.

4. A method for establishing a chrome-like coating on a smooth surface, comprising:
pouring into a can, a mixture containing a liquid carrier and particles of aluminum that each has the same thickness on the order of magnitude of 0.0005 inch, and pressurizing the mixture under an initial pressure of at least 20 psi;
passing said mixture through a nozzle and at said smooth surface.

5. The method described in claim 4, wherein:
said step of passing said mixture through a nozzle includes passing the mixture through a nozzle aperture with a cross-section that is elongated and that has a length that is at least 150% of its width.
